(19) United States
(12) Patent Application Publication
(10) Pub. No.: US 2005/0260388 A1
(43) Pub. Date: Nov. 24, 2005

(54) Apparatus and method of fabricating an ophthalmic lens for wavefront correction using spatially localized curing of photo-polymerization materials

(76) Inventor: Shui T. Lai, Encinitas, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/851,300

(22) Filed: May 21, 2004

(51) Int. Cl. B32B 3/00

(52) U.S. Cl. 428/156

(57) ABSTRACT

A method for making an optical compensating element for, e.g., correcting aberrations in human vision or other applications. A curable material is held between two plates, and based on the aberrations sought to be corrected, a desired curing contour is determined to establish a line below which a predetermined index of refraction will be obtained. A light beam is focused along the line to cure material along the line. Uncured material above the line can be removed and uncured material below the line then cured in bulk, to speed the manufacturing process.

### RELATED APPLICATIONS

This application is related to U.S. patent application Ser. No. 09/875,447, entitled “WAVEFRONT ABERROMETER AND METHOD OF MANUFACTURING,” filed Jun. 4, 2001; U.S. patent application Ser. No. 10/218,049 entitled “APPARATUS AND METHOD OF CORRECTING HIGHER-ORDER ABERRATIONS OF THE HUMAN EYE,” filed Aug. 12, 2002 and U.S. patent application Ser. No. 10/265,517, entitled “APPARATUS AND METHOD OF FABRICATING A COMPENSATING ELEMENT FOR WAVEFRONT CORRECTION USING SPATIALLY LOCALIZED CURING OF RESIN MIXTURES,” filed Oct. 3, 2002, each of which is hereby incorporated by reference in its entirety.

### BACKGROUND OF THE INVENTION

1. Field of the Invention

The present invention relates generally to producing refractive elements for use in optical systems.

2. Description of the Related Art

In many optical systems it is common to assume that the light passing through the system is limited to paraxial rays, specifically, rays that are near the optical axis and that are sustained within small angles. With this assumption, corrective optics that conveniently can be limited to have only spherical surfaces can be provided to correct any aberrations that are present in images generated by the optical systems. While aspheric optics can be produced, to do so is costly and time consuming.

An example of the above problem is the human eye. It is conventionally assumed that ocular imperfections are limited to lower order imperfections, including the imperfections commonly called “astigmatism” and “defocus”, that can be corrected by lenses having spherical surfaces. However, in reality optical systems including the human eye rarely are limited to what is conventionally assumed for purposes of providing corrective optics that have only spherical surfaces. In the case of the human eye, for instance, higher order imperfections can exist, including but not limited to those imperfections known as “coma” and “trefoil.” These imperfections unfortunately cannot be corrected by conventional glasses or contact lenses, leaving patients with less than optimum vision even after the best available corrective lenses have been prescribed.

Moreover, it is often difficult to simultaneously minimize all aberrations. Indeed, corrections to an optical system to minimize one type of aberration may result in the increase in one of the other aberrations. As but one example, decreasing coma can result in increasing spherical aberrations.

Furthermore, as understood herein it is often necessary to correct aberrations in an optical system that are introduced during manufacturing. This process can be iterative and time consuming, requiring, as it does, assembly, alignment, and performance evaluation to identify aberrations, followed by disassembly, polishing or grinding to correct the aberrations, and then reassembling and retest. Several iterations might be needed before a suitable system is developed.

### SUMMARY OF THE INVENTION

One aspect of the invention is directed to a method for manufacturing a compensating element and the compensating element having a layer of curable material. The method includes determining a desired refraction contour, and then focusing a light beam along the contour to cure the material along the contour. The method also includes removing regions of the material above the contour. Then, substantially all the material below the contour is cured in bulk, by irradiating the material below the contour with a light beam. Preferably, substantially all the material below the contour is cured by irradiating, at once, substantially all the material below the contour.

Preferably, the material along the contour is cured by focusing the light beam to successive positions along the contour. The light beam may be characterized by a beam waist, and the beam waist is preferably in the range of 0.1 microns to 200 microns, and may be formed with a cone angle preferably between 0.002 and 1.5 radians.

In one embodiment, first and second transparent plates hold the material therebetween. In a preferred embodiment, prior to curing, the material includes at least one monomer and at least one polymerization initiator. The material may be epoxy or other photo-polymerizable material.

In another aspect, a method for manufacturing a compensating element having a layer of curable material includes curing only a desired refraction contour in the material, leaving a volume of uncured material confined by the refraction contour, removing the material outside of the confined volume and then bulk curing the volume of uncured material confined by the contour.

In still another aspect, a method for making an ophthalmic spectacle lenses and contact lenses includes holding a curable material between two transparent support plates. A surface, or contour, is cured in the material, with the shape of the contour being determined based on a measured wavefront from a patient's eye. After the contour has been cured, material on at least one side of the contour is bulk cured.

In yet another aspect, a compensating optical element includes a first layer formed by directing a light beam along a predetermined contour in a volume of curable material to cure the material along the contour and a second layer formed below the first layer by irradiating the curable material below the contour with a light beam. Preferably the optical element includes a third layer formed by replacing at least a portion of the curable material above the first layer with an optically stable material.

In another aspect, an apparatus for manufacturing a correcting element having at least one transparent element and a curable material includes at least one radiation source. The radiation source may provide a suitable light source for curing the material. A lens may be configured to focus light from the radiation source on a focal point. An X-Y-Z translation mechanism is configured to translate the focal point relative to the curable material. A controller is configured to direct the translation mechanism to translate the focal point along a predetermined contour in the curable layer. Preferably, at least one radiation source is configured to bulk cure at least a portion of the curable material.

### BRIEF DESCRIPTION OF THE DRAWINGS

FIG. 1 is a cross-sectional view of a correcting element, prior to curing.

FIG. 2 is a flow chart of a method for manufacturing a correcting element.

FIG. 2A is a schematic diagram depicting one embodiment of an apparatus for manufacturing the correcting element of FIG. 1.

FIG. 3 is a schematic diagram of a wavefront having aberrations to be compensated.

FIG. 4 is a schematic diagram of an index of refraction profile for curing a lens to compensate for aberrations shown in the wavefront of FIG. 3.

FIG. 5 is a cross-sectional view of the correcting element after curing along the contour.

FIG. 6 is a cross-sectional view of the correcting element after bulk curing the material below the contour.

FIG. 7 is a cross-sectional view of the correcting element after bulk filling in the void above the contour.

### DETAILED DESCRIPTION

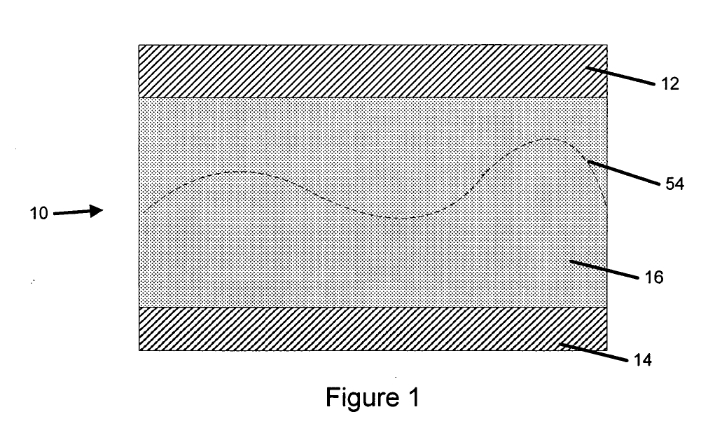

Referring initially to FIG. 1, a correcting element is shown prior to curing, generally designated 10. As shown, the correcting element 10 may include a first rigid or flexible transparent plate 12, a second rigid or flexible transparent plate 14, and a layer of material 16 of a curable material such as epoxy sandwiched therebetween. As shown in FIG. 1, the transparent plates 12, 14 can be planar, or one or both can include an outwardly-facing curved surface which may exhibit a pre-existing refractive power. If desired, a barrier (not shown) can be used to contain the epoxy 16 between the plates 12, 14 prior to, and following, the below-described curing of the epoxy.

While the preferred material 16 is epoxy, it is to be understood that it is but one example of the material 16, which can generally be a curable resin comprised of monomers and polymerization initiators. In one embodiment, the resin is light curable. The refractive index of the material 16 changes as it is cured. The extent of curing is determined by the percentage of cross-linking between the monomers within the material 16. Examples of curable photo-polymerization materials include curable polymers selected from the family of epoxide, urethane, thiol-ene, acrylate, cellulose ester, and mercapto-ester polymers. Preferred examples of suitable photo-polymerizable material are thiol and ene polymer formulations, VLE-4101 UV-Visible Light Cure Epoxy, available from Star Technology, Inc., or Optical Adhesive #63, U.V. Curing, available from Norland Products, Inc. Typically, these resins are curable by exposure to ultraviolet (UV) light or visible light radiation in the range of 300 to 550 nanometers (300-550 nm). Generally, appropriate materials exhibit an index of refraction change upon curing. In addition, for light-curable materials, the corresponding curing light source may have appropriate curing wavelengths, e.g., wavelengths that are within the range of 250 nm to 3000 nm.

It is to be appreciated, however, that many other suitable resins exist which exhibit a similar change in its index of refraction upon exposure to a curing radiation or energy such as light. For example, other monomers that polymerize into long-chain molecules using photo-initiators may be used in the present invention. A suitable monomer may be chosen from the family of epoxides, urethanes, thiol-enes, acrylates, cellulose esters, or mercapto-esters, and a broad class of epoxies. Also, for example, a suitable photo-initiator may be chosen from alpha cleavage photoinitiators such as the benzoin ethers, benzil ketals, acetophenones, or phosphine oxides, or hydrogen abstraction photoinitiators such as the benzophenones, thioxanthones, camphorquinones, or bisimidazole, or cationic photoinitiators such as the aryldiazonium salts, arylsulfonium and aryliodonium salts, or ferrocenium salts. Alternatively, other photoinitiators such as the phenylphosphonium benzophene salts, aryl tert-butyl peresters, titanocene, or NMM may be used.

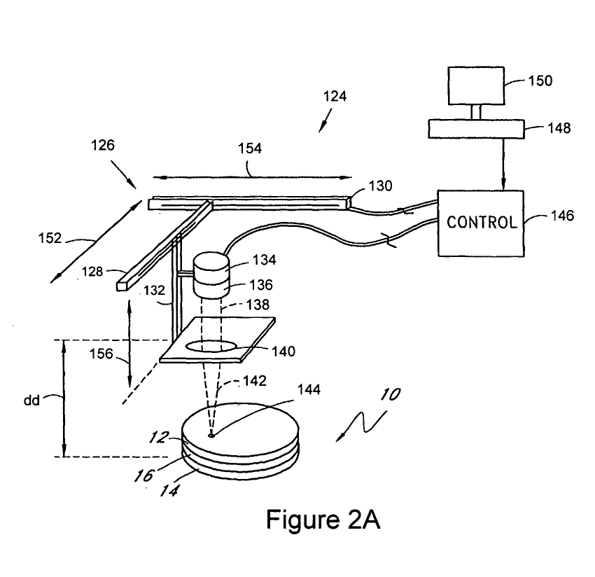

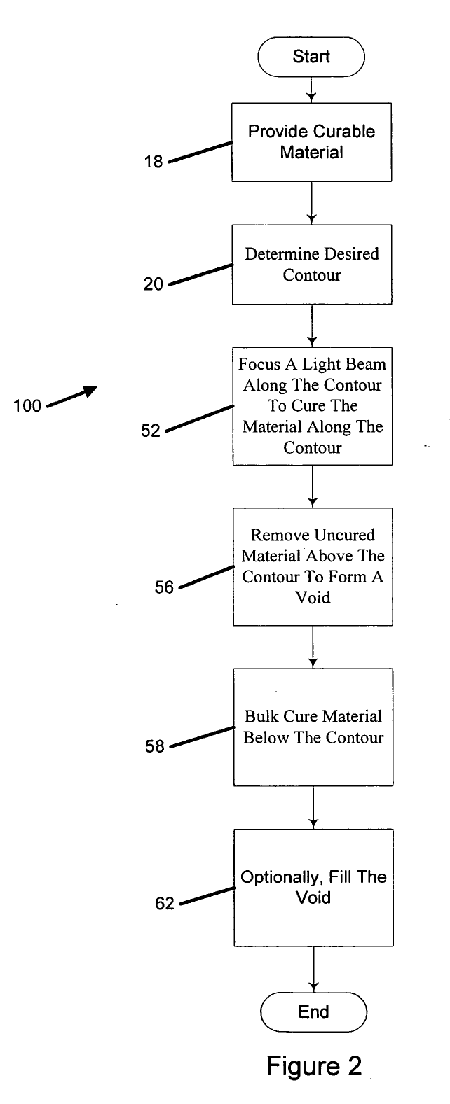

Now referring to FIG. 2, an embodiment of the method 100 for manufacturing the element will be described. From a start block, the method commences with a step 18, where the curable material 16 is provided. Next, at a step 20, a desired contour 54 within the material 16 is determined. In determining the desired contour 54, not only may the contour be determined, but also, in one embodiment, the thickness of material that will remain below the contour 54 is determined. Stated differently, both the contour, and the location of the contour relative to the plates 12, 14, may be determined to provide a correcting element having any desirable spatial retardation distribution utilizing the index of refraction change of the material 16 in its cured state.

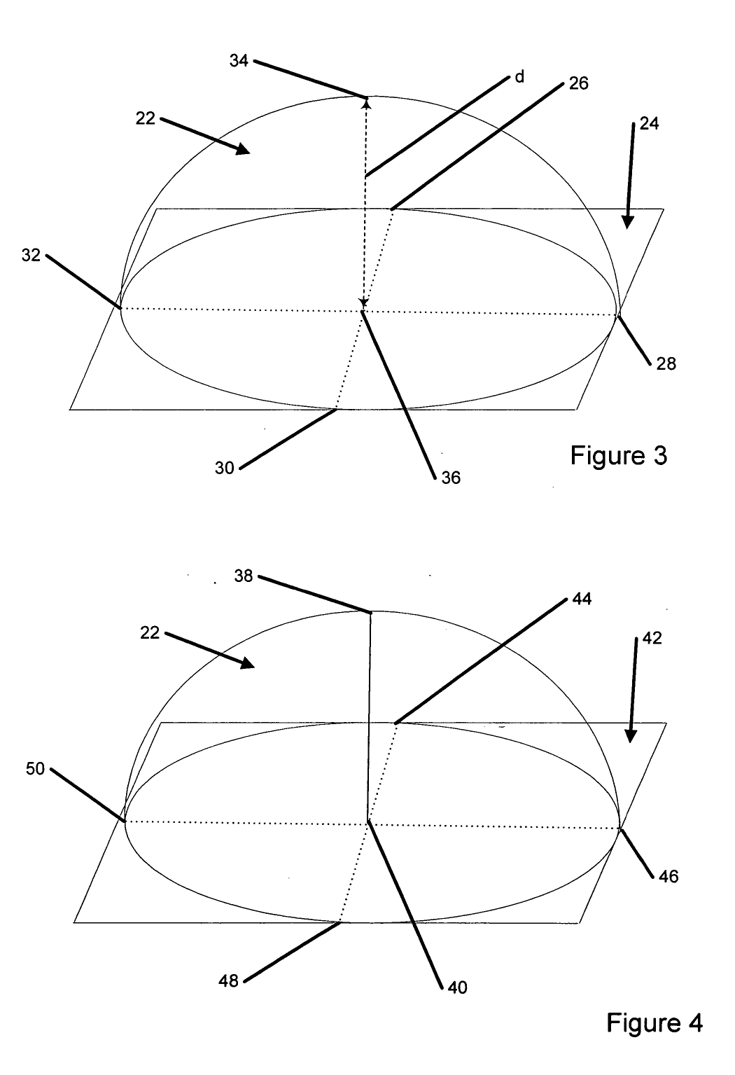

FIG. 3 illustrates how the desired contour 54 can be determined. A wavefront 22 is shown that, for illustration, is a divergent wave which may consist of spherical, astigmatism, and higher order aberrations. Such a wavefront can be, for example, measured or determined from an eye using methods and systems known to those of ordinary skill, such as a system that employs Shack-Hartmann, grating-based wavefront sensing technology, or spatially resolved refractometry method. At an imaginary cross sectional plane 24, the wavefront has intersections located at points 26, 28, 30, 32. The peak of the wavefront is indicated at 34, which is traveling ahead of the intersections 26, 28, 30, 32. The distance between the peak 34 and the intersections is typically expressed in the units of physical distance in space. The peak 34 has a projected point 36 on the plane 24.

To compensate for this wavefront, an embodiment of the method 100 is applied to create a wavefront retardation contour in the material 16 that will slow down the peak 34. Accordingly, the desired contour 54 is a surface of a portion of the material 16 that exhibits, after curing, an index of refraction that results in the conjugate of the wavefront 22 such that a plane wave exits the correcting device. An illustrative contour 54 or curing profile is shown in FIG. 4, which has a three dimensional distribution profile 38 that is identical that of the profile of the wave 22 shown in FIG. 3.

Specifically, in one preferred embodiment, assume that the unit of retardation required for an ideal compensation may be calculated as follows. Further assume that the difference Δn of the index of refraction between cured and uncured material 16 is known. Typically this index of refraction is in the range of 0.001 to 0.1. The maximum retardation required is the physical distance “d” between the wave 22 peak 34, and its projection point 36 on the plane 24. The required thickness of the material 16 consequently is at least d/Δn. In the curing profile for the material 16, the scale of the magnitude of the retardation is such that the magnitude of thickness of the cured epoxy or the integrated index difference at a profile peak 38 to its projection 40 on a cross-sectional plane 42 is d/Δn. The effect of such a profile is that the peak 34 of the wave 22 experiences the most retardation or phase adjustment, and the wave at the intersections 26, 28, 30, 32 experiences no retardation at corresponding locations 44, 46, 48, 50 of the index profile which are in the uncured portion of the material 16. Accordingly, the desired contour of the material 16 after curing is such that its index of refraction establishes a profile that matches the profile of the wavefront sought to be compensated for.

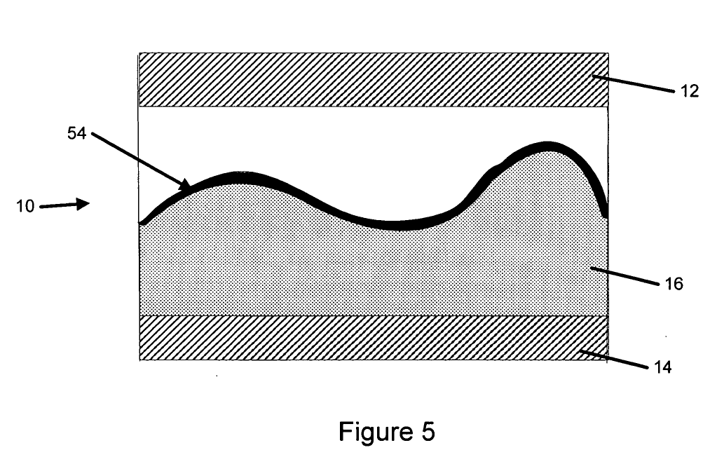

Returning to the process 100 depicted in FIG. 2, once the desired contour 54 has been determined, at a step 52 the material 16 is cured along the desired contour 54, as depicted in FIG. 5. Material above and below the contour 54 may remain substantially uncured at this step.

The curing can be undertaken by directing an energy or radiation source along the contour line, for example using a light source in combination with a beam shaping unit, details of which are set forth in the above-referenced applications. For convenience, portions of the previous disclosure are repeated herein. The light source with beam shaping unit creates a light beam which, in a preferred embodiment, is substantially convergent and tightly focused into a small spatial volume. In one exemplary, non-limiting embodiment, the light beam may pass through a focusing lens to form a converging, or focusing, light beam that is directed toward the correcting element 10, where the light beam passes through the first transparent plate 12 to focus on the desired contour line 54 which is a 2 dimensional cross section of a three dimensional contour surface. This irradiates the monomer (e.g., material 16) on the contour 54, which activates the photo-initiator and begins the curing process within the material 16. The curing process results in a corresponding change of the index of refraction within the material. Terminating the exposure to the light ceases the curing, thereby ceasing the change of the index of refraction.

FIG. 2A is schematic diagram of one embodiment of a manufacturing system 124 for curing the material 16. The embodiment of system 124 includes an X-Y-Z scanning unit 26 having an X-direction rail 128 and a Y-direction rail 130. Also, the embodiment of.the system 124 includes a Z-direction rail 132 extending from the X- or Y-direction rails. A light source 134 having a beam shaping unit 136 is attached to and is movable on the Z-direction rail 132. The beam shaping unit 136 may include spatial filtering and beam collimation components to produce a higher quality beam.

The light source 134, in combination with the beam shaping unit 136, direct a light beam 138 that, in a preferred embodiment, passes through a focusing lens 140 to form a converging, or focused, light beam 142 that is directed toward the correcting element 10. The focused light beam 142 passes through the first transparent plate 12 to focus at 144 within the layer 16. In one exemplary embodiment, the focusing lens 140 is a microscope objective piece with a large numerical aperture.

The light source 134 irradiates the material 16 along the contour 54, which activates the photo-initiator and begins the curing process within the surrounding material 16. The curing process results in a corresponding change of the index of refraction of the material 16 along the contour 54. Terminating the exposure to the light ceases the curing of the material 16, and thereby ceases the change of the index of refraction exhibited by the material 16 along contour 54.

The activation and power level of the light source 134 and its position along the X-Y-Z axes may be controlled by a controller 146, which is electrically connected to the light source 134 and to components for moving the light source 134 along one or more of the rails 128, 130, and 132. The controller 146 may receive instructions regarding the desired index of refraction profile to be implemented from a computer 148 with associated monitor 150. More particularly, by moving the light source 134 along the rails 128, 130, 132 in the directions respectively indicated by arrows 152, 154, 566, and by establishing the power of the light source 134, the layer 16 may be cured along the contour 54. The depth in the resin mixture 16 of the focal point 144 is established by appropriately establishing the distance dd between focusing lens 140 and layer 16.

In a preferred embodiment, the power density of the light source 134 is controlled by adjusting the current to the light source. In another embodiment, the amount of light delivered into the layer 16 may be controlled by using a constant light source 134 power level with variable light attenuator methods, including Pockel cells or other polarization rotation means and a polarized discriminator. It is to be understood that other light intensity control methods can also be used.

In another embodiment, the light beam 142 may be stationary and the optical element is translated in three dimensional space. The contour 54 is thereby created by curing the polymer material at the light focal point. The converging light beam passes through the transparent plate 12 and converges within the material 16. Specifically, the light ray edges of the beam converge at a focal point that is on the contour 54 to cure the material 16 at the focal point. Then, the light beam is moved to the point on the contour 54 that is adjacent to the just-cured point to cure the next point, and so on, until the entire contour 54 has been cured.

While the term “focal point” is used above, it is to be understood that the light beam at its point of focus is not at a true “point”, which in mathematics has no volume, but rather is focused in a volume referred to as a “beam waist” which represents the region in the material 16 which will be cured by exposure to the converging light beam. Generally speaking and without limitation, a beam with a cone angle that is in the range of 0.002 radians to 1.5 radians may be used.

Preferably, the distance between curing volumes along the desired contour 54 should be less than the diameter, i.e., the beam waist, of the light beam, creating an overlap region. In a preferred embodiment, the size of the beam overlap region can vary between fifteen to eighty five percent (15%-85%) of the size of the beam waist. In a particularly preferred, non-limiting embodiment, the size of the beam overlap region can be between forty to sixty percent (40%-60%) of the size of the beam waist.

In a preferred embodiment, the beam waist is in the range of twenty microns (20 μm) or less. However, beam waists between 0.1 microns and two hundred microns may also be used. For the more demanding situations where the index profile is microscopic in dimensions, a diffraction limited focusing configuration with microscopic objective can be used. As an example, a light source can be used that produces a 350 nm wavelength light beam in conjunction with a beam focusing lens with a numerical aperture of 0.5. With this combination of structure, the beam waist has a length of about 0.86 microns (0.86 (m) in air, and in an epoxy with an index of refraction of 1.54, as an example, the beam waist is 1.35 microns, with the depth of focus being 0.87 microns below the surface of the epoxy.

It is to be understood that the curing volumes along the contour 54 may be sequential and contiguous to each other, or the scan sequence may be randomly accessed, such that the new curing location is isolated from the previous location, with no overlap of the beam waists.

Returning to FIG. 2, and moving to a step 56 of the process 100, once the material 16 along the contour 54 has been cured, excess, uncured material 16 above the contour, i.e., between the plate 12 and the contour 54, may, in one embodiment, be removed. This can be done by removing the plate 12 and then removing the excess uncured material, or it can be done by leaving the plate 12 in place and flushing the excess uncured material away using a suitable solvent.

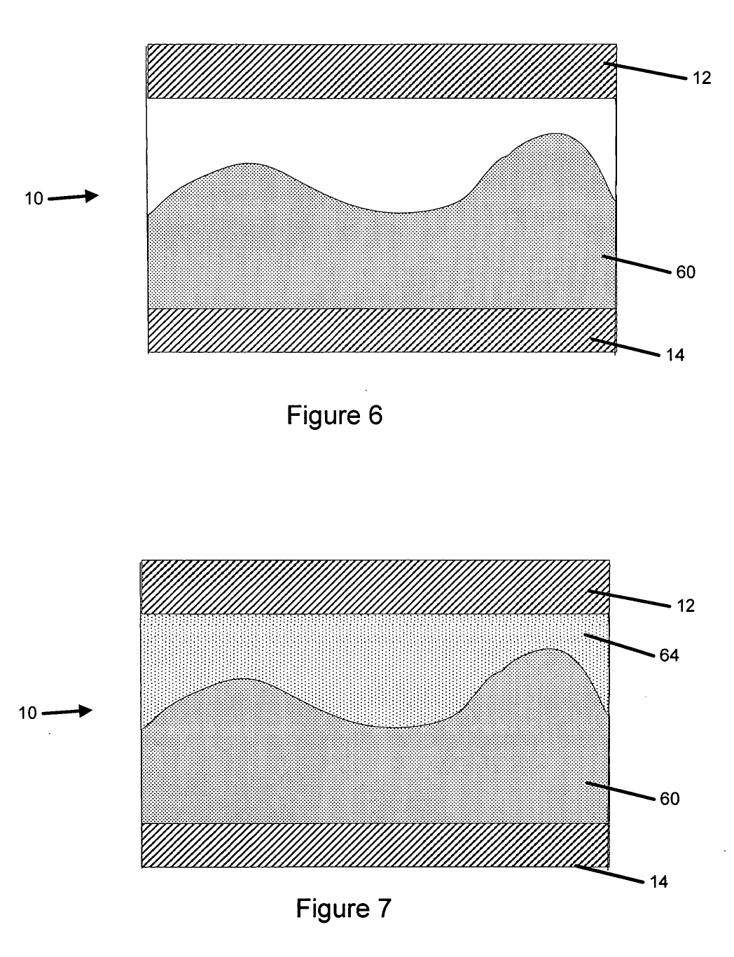

Then, proceeding to a step 58, the remaining uncured material 16, i.e., the material 16 below the contour 54, is cured in bulk by, e.g., bulk radiating the material 16 below the contour 54, to establish a cured volume 60 as shown in FIG. 6. In other words, instead of painstakingly focusing a curing beam on successive small volumes within the remaining material, a single, potentially unfocussed light beam can be directed onto substantially all of the remaining uncured volume to cure it at once, thereby reducing processing time and expense. The resulting index of refraction of the cured volume 60, in cooperation with the contour of the line 54, produces a conjugate of the wavefront sought to be corrected, in accordance with the disclosure above.

In one embodiment of the manufacturing system 124 of FIG. 2A, the lens 140 may be removed from the optical path to enable bulk curing to form the cured volume 60. In another embodiment, the system 124 may comprise a secondary light source (not pictured) which bulk cures the volume 60.

In one embodiment, the process continues to a step 62 of FIG. 2. The volume or void above the contour 54 may be refilled with an optically stable fluid or other material 64, as shown in FIG. 7. The optically stable material exhibits no refractive index change when exposed to radiation. In another embodiment, the volume may be refilled with same or similar material as the material 16, but without any photo-initiator to prevent curing action upon exposure of light. In yet another embodiment, the volume is refilled with epoxy containing curing inhibitor such as phenol, or hydroquinone derivatives, that inhibit curing even if the epoxy is exposed to radiation. In still another embodiment, an optical coating is applied to the plates 12, 14 to protect the material from exposure to a predetermined range of wavelengths, dependent on the material that would otherwise cure it.

By removing the uncured material and replacing its volume with or without an optically stable material, a stable correcting element 10 can be established that resists changes to its index of refraction under long term exposure to light sources. This is particularly useful in environments where the correcting element 10 would be exposed to sunlight or other light sources which might contain wavelengths which would cause further curing of the previously un-cured material.

In various embodiments, the material 16 need not necessarily be completely cured, depending on the curing plan. Partially cured epoxy, for instance, contributes less in the index of refraction change than a completely cured epoxy for the same volume. Thus, a mixture of completely and partially cured material may also serve the purpose of wavefront compensation.

Embodiments of the invention are useful in providing a stable optical wave plate which may exhibit any retardation level, with any spatial variation. Embodiments of the correcting element 10 are applicable to correct distortion in a light beam of a cross sectional area ranging, for example, from a millimeter to several meters in diameter. The optical elements 10 may correct not just low numbers of wave distortions in the range of a fraction of a wave to a few waves, but may correct up to hundreds of waves. Various embodiments may include a stand-alone wavefront distortion corrector, which includes a refractive power correction.

In one embodiment, the surface non-flatness of a mirror is corrected using present principles by providing an appropriately cured element in front of the mirror. In another embodiment, the correcting element is configured as a lens which compensates for imperfections in another optics lens in accordance with principles set forth above.

Additionally, certain embodiments are particularly useful in the construction of customized ophthalmic lenses which have refractive power established in increments of fractions of a wavelength over the entire lens area, such that the lens produces localized wavefront correction tailored to the aberration of the eye of an individual. In a preferred embodiment, the aberrations of an eye are measured as described above. The outcomes of this wavefront measurement can include piston, tip, tilt, defocus (spherical power), astigmatism and its axis, and the higher order aberrations describable in the third and higher order Zemike polynomials. The prism (tip, tilt), spherical, and astigmatism components, which are referred to as refractive powers, can be corrected with currently available ophthalmic lens with the best possible match, typically limited to 1/8 diopter increments. An embodiment of the method 100 is then applied to complete the correction of aberrations including any residual errors of the sphere and astigmatism due to mechanical grinding and polishing and the high order aberrations which the current conventional ophthalmic lens can not correct. In such an implementation, a conventional ophthalmic lens can form one of the plates 12, 14, a cover lens can form the other plate, and a thin layer of cured material disposed therebetween and cured as described above. As a non-limiting example, the conventional lens can be a lens with negative refractive power, typically for myopia patients, and the outer surface of the conventional lens, i.e., the surface that is farthest way from the eye, has less curvature than the inner surface. The cover lens may or may not have any focusing power and it is preferably thin, to minimize the overall thickness of the combined lens system. It may have a surface curvature closely matched with that of the outer surface of the conventional lens. The combined structure is then measured, for example in accordance with present principles, to determine the overall refractive power and aberration including the cover lens and curable material. This is mapped to a curing plan for the material 16 by subtracting from the eye measurement the correction and aberration of the combined lens structure to render a residual aberration profile. Then the material is cured in accordance with principles above to cancel the residual aberration. The area of the ophthalmic lens can be in the range of 3 mm to 70 mm, and not less than the pupil size of the patient. The optical center of the lens is then aligned with the entrance of the pupil location on a spectacle frame, and the lens is then cut to the correct size to fit into the spectacle for the patient.

Another embodiment is directed to improving the resolution of viewing instruments such as telescopes, microscopes, ophthalmic diagnostic instruments including confocal scanning ophthalmoscopes, and fundus cameras. In all cases, each viewing instrument includes refractive elements such lenses, reflective elements such as mirrors and beam splitters, and diffractive elements such as gratings and acousto- and electro-optical crystals. Embodiments of the present invention can eliminate costly manufacturing of such apparatus by using lower precision optics which may reduce the cost by a factor of 10-50 times in comparison to a high precision optic element and by compensating for the attendant residual aberrations with correcting elements such as are described above.

In one embodiment, the aberrations of the selected optical system are first analyzed and measured using interferometry or wavefront sensing method and then mapped to a material 16 curing plan for an appropriately configured correcting element, which cancels the wavefront aberrations of the optical system. The optical system being corrected can, if desired, include the aberrations introduced by a particular user's eye, so that these aberrations are also compensated for. In the case of a telescope, a correcting element 10 is positioned next to the objective lens of the telescope, where the image rays are approximately collimated. In the case of microscope, a correcting element 10 is positioned next to the eyepiece.

In the case of a ftndus camera, which can be compensated for similarly to microscope compensation, aberrations of the patient's eye to be examined may limit the resolution of the camera. If so, a correcting element 10 can be first constructed by, for example, process 100, to cancel the aberrations of the eye under cycloplegia conditions wherein the accommodative muscles of the eye are paralyzed. The separate correcting element 10 for the correction of the aberrations of the camera may then be attached to the camera.

While the particular APPARATUS AND METHOD OF FABRICATING AN OPHTHALMIC LENS FOR WAVEFRONT CORRECTION USING SPATIALLY LOCALIZED CURING OF PHOTO-POLYMERIZATION MATERIALS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

1. A method for manufacturing an optical element compensating for wavefront error of an optical system having a layer of curable material, comprising:
determining a refraction contour;
directing a light beam along the contour to cure the curable material along the contour;
removing regions of the curable material above the contour; and
curing substantially all the curable material below the contour by irradiating the curable material below the contour with a light beam.

2. The method of claim 1, wherein curing substantially all the curable material below the contour comprises irradiating at once substantially all the curable material below the contour.

3. The method of claim 1, wherein the curable material along the contour is cured by focusing the light beam to successive positions along the contour.

4. The method of claim 1, wherein the light beam is characterized by a beam waist, and the beam waist is in the range of 0.1 microns to 200 microns.

5. The method of claim 1 wherein determining the desired refraction contour comprises measuring a wavefront of the optical system.

6. The method of claim 1, further comprising providing first and second transparent plates to hold the curable material therebetween.

7. The method of claim 1, wherein at least prior to curing the curable material includes at least one polymer and at least one polymerization initiator.

8. The method of claim 1, wherein the curable material includes photo-polymerizable polymer and monomer, epoxy.

9. A compensating optical element comprising:
a first layer formed by directing a light beam along a predetermined contour in a volume of curable material to cure the material along the contour; and
a second layer formed below the first layer by irradiating the curable material below the contour with a light beam.

10. The optical element of claim 9, wherein the second layer is formed below the first layer by bulk curing.

11. The optical element of claim 9, further comprising a third layer formed by replacing at least a portion of the curable material above the first layer with an optically stable material.

12. The optical element of claim 11, wherein the optically stable material comprises a fluid.

13. The optical element of claim 11, wherein the optically stable material comprises an epoxy and a curing inhibitor.

14. The optical element of claim 9, further comprising an optical coating configured to protect the curable material from exposure to at least one wavelength of curing radiation.

15. The optical element of claim 9, further comprising a first and second transparent plate configured to secure the first and second layer therebetween.

16. The optical element of claim 15, wherein the first plate comprises a first lens.

17. The optical element of claim 16, wherein the second plate comprises a second lens.

18. The optical element of claim 17, wherein the second lens has a curvature that is less than a curvature of the first lens.

19. The optical element of claim 17, wherein the predetermined contour is determined based at least partly on optical properties of the second lens.

20. The optical element of claim 17, wherein the predetermined contour is determined based at least partly on compensating for residual errors of the first lens.

21. The optical element of claim 16, wherein the predetermined contour is determined based at least partly on optical properties of the first lens.

22. The optical element of claim 21, wherein the contour is determined based on at least one optical property of the first lens that is selected from the group consisting of sphere and cylinder.

23. A method for manufacturing a compensating element having a layer of curable material, comprising:
curing only a desired refraction contour in the material, leaving a volume of uncured material adjacent to the refraction contour;
removing a volume of uncured material, then
bulk curing the volume of the remaining uncured material.

24. The method of claim 23, wherein at least one curing act is undertaken by focusing a light beam in the material.

25. The method of claim 24, wherein the focusing of the light beam in the material comprises focusing the light beam on successive positions along the contour.

26. The method of claim 23, further comprising removing regions of the material above the contour.

27. The method of claim 23, further comprising:
measuring a wavefront from an eye; and
determining the refraction contour based upon the measured wavefront.

28. The method of claim 23, further comprising forming the light beam with a cone angle between 0.002 and 1.5 radians.

29. The method of claim 23, further comprising providing first and second transparent plates to hold the material therebetween.

30. The method of claim 23, wherein at least prior to curing the material includes at least one monomer and at least one polymerization initiator.

31. A method for making an ophthalmic lens, comprising the acts of:
securing a curable material between at least two transparent support plates;
curing a desired contour in the material, the shape of the contour being determined at least in part based on a measured wavefront from a patient's eye; and
after the contour has been cured, bulk curing material on at least one side of the contour.

32. The method of claim 31, wherein at least one curing act is undertaken by focusing a light beam in the material.

33. The method of claim 31, further comprising removing regions of the material above the contour, prior or subsequent to the bulk curing act.

34. The method of claim 31, wherein the material along the contour is cured by focusing the light beam to successive positions along the contour.

35. The method of claim 31, wherein the light beam is characterized by a beam waist, and the beam waist is in the range of 0.1 microns to 200 microns.

36. The method of claim 31, further comprising forming the light beam with a cone angle between 0.002 and 1.5 radians.

37. An apparatus for manufacturing a correcting element having at least one transparent element and a curable material, the apparatus comprising:
at least one radiation source, providing a suitable light source for curing the material;
at least one lens configured to focus light from the at least one radiation source on a focal point;
at least one X-Y-Z translation mechanism configured to translate the focal point relative to the curable material; and
a controller configured to direct the translation mechanism to translate the focal point along a predetermined contour in the curable layer.

38. The apparatus of claim 37, further comprising at least one radiation source configured to bulk cure at least a portion of the curable material.

39. The apparatus of claim 37, wherein the at least one radiation source is configured to bulk cure at least a portion of the curable material.
